(19) United States
(12) Patent Application Publication
(10) Pub. No.: US 2006/0150010 A1
(43) Pub. Date: Jul. 6, 2006

(54) Memory-controller-embedded apparatus and procedure for achieving system-directed checkpointing without operating-system kernel support

(76) Inventors: Jack J. Stiffler, Marion, MA (US); Donald D. Burn, Westborough, MA (US)

Correspondence Address: J.J. STIFFLER, 286 DELANO ROAD, MARION, MA, 02738, US

(21) Appl. No.: 11/301,814

(22) Filed: Dec. 13, 2005

Related U.S. Application Data
(60) Provisional application No. 60/640,356, filed on Jan. 3, 2005.

(51) Int. Cl. G06F 11/00

(52) U.S. Cl. 714/13

(57) ABSTRACT

System-directed checkpointing is enabled in otherwise standard computers through relatively straightforward enhancements to the computer's memory controller. Different embodiments of the invention can be used to support: local and remote post-image checkpointing using a memory-resident address buffer for storing the addresses of modified data blocks, either with or without requiring the processor caches to be flushed at each checkpoint; local and remote post-image checkpointing using either memory- or I/O-resident buffers for both the addresses and the data associated with blocks modified since the last checkpoint and supporting background buffer-to-shadow copying; remote and local post-image checkpointing using bit-map memories thereby avoiding the need for either address or data buffers while still supporting background data copying and either with or without requiring caches to be flushed to effect a checkpoint; local post-image checkpointing using a two-bit-per-memory-block state memory that eliminates the need for any data to be copied from one memory location to another; and pre-image local checkpointing again either with or without requiring caches to be flushed for checkpointing purposes. Since most of these implementations have advantages and disadvantages over the others and since similar mechanisms are used in the memory controller for all of these options, the controller can be implemented to support all of them with a hardwired or settable status register defining which is to be supported in a given situation. Alternatively, since some of these implementations require somewhat less extensive memory controller enhancements, the controller can be designed to support only one or a small subset of these embodiments with a correspondingly smaller perturbation to its more standard implementation.

### RELATED APPLICATIONS

This application is related to, and claims priority of, U.S. provisional application Ser. No. 60/640,356, filed on Jan. 3, 2005, by Jack J. Stiffler and Donald Burn.

### FIELD OF THE INVENTION

This invention relates to apparatus and techniques for achieving fault tolerance in computer systems and, more particularly, to techniques and apparatus for establishing and recording a consistent system state from which all running applications can be safely resumed following a fault.

### BACKGROUND OF THE INVENTION

“Checkpointing” has long been used as a method for achieving fault tolerance in computer systems. It is a procedure for establishing and recording a consistent system state from which all running applications can be safely resumed following a fault. In particular, in order to checkpoint a system, the complete state of the system, that is, the contents of all processor and I/O registers, cache memories, and main memory at a specific instance in time, is periodically recorded to form a series of checkpointed states. When a fault is detected, the system, possibly after first diagnosing the cause of the fault and circumventing any malfunctioning component, is returned to the last checkpointed state by restoring the contents of all registers, caches and main memory from the values stored during the last checkpoint. The system then resumes normal operation. If inputs and outputs (I/Os) to and from the computer are correctly handled, and if, in particular, the communication protocols being supported provide appropriate protection against momentary interruptions, this resumption from the last checkpointed state can be effected with no loss of data or program continuity. In most cases, the resumption is completely transparently to users of the computer.

Checkpointing has been accomplished in commercial computers at two different levels. Early checkpoint-based fault-tolerant computers relied on application-directed checkpointing. In this technique, one or more backup computers were designated for each running application. The application was then designed, or modified, to send periodically to its backup computer, all state information that would be needed to resume the application should the computer on which it was currently running fail in some way before the application was able to establish the next checkpoint.

This type of checkpointing could be accomplished without any specialized hardware, but required that all recoverable applications be specially designed to support this feature, since most applications would normally not write the appropriate information to a backup computer. This special design placed a severe burden on the application programmer not only to ensure that checkpoints were regularly established, but also to recognize what information had to be sent to the backup computer. Therefore, in general, application-directed checkpointing has been used only for those programs that have been deemed especially critical and therefore worth the significantly greater effort required to program them to support checkpointing.

System-directed checkpointing has also been implemented in commercial computer systems. The term “system-directed” refers to the fact that checkpointing is accomplished entirely at the system software level and applications do not have to be modified in any way to take advantage of the fault-recovery capability offered through checkpointing. System-directed checkpointing has the distinct advantage of alleviating the application programmer from all responsibility for establishing checkpoints. Unfortunately, its implementation has been accomplished through the use of specialized hardware and software, making it virtually impossible for such systems to remain competitive in an era of rapidly advancing state-of-the-art commodity computers.

More recently, techniques have been disclosed for achieving system-directed checkpointing on standard computer platforms. These techniques, however, all require either specialized plug-in hardware components or else modifications to the operating system kernel. The plug-in components intercept either reads from memory, or writes to memory, so that the information needed to establish a checkpoint can be made available to the checkpointing software. This procedure suffers from the fact that the intercepting hardware introduces additional delays in the processor-to-memory path, making it difficult to meet the increasingly tight timing requirements for memory access in state-of-the-art computers. This problem can be circumvented if the operating system kernel is modified to enable certain memory writes to be interrupted momentarily so that either the pre-image of the addressed section of memory, or the address itself, can be captured and recorded elsewhere in memory. The problem with this approach is that it can be implemented only on systems having operating systems that have be so modified.

### SUMMARY OF THE INVENTION

Additional features are embedded in an otherwise standard memory controller enabling it to support a number of different system-directed checkpoint strategies. Moreover, subsets of these features can support each of the various strategies individually. In particular, in the simplest embodiment of the present invention, the features embedded in the controller enable it to store, into a buffer located either in a dedicated region of main memory or to a designated I/O device, the address of each block of memory being written to, and, optionally, a copy of the data being written. In addition, it is also given the ability, under explicit command, to handle all accesses to memory from any I/O device in a non-standard way that prevents checkpointed data from being corrupted and prevents protected data from being inadvertently released. These enhancements along with the appropriate software support make it possible to capture and retain the computer state at each checkpoint by flushing all of the modified contents of each processor's cache to main memory and then transferring the memory blocks that have been modified since the last checkpoint either to a local shadow memory or over an I/O communication link to a backup computer and to restore the checkpointed state following a fault.

In a slightly more complex embodiment, the controller is also given the ability, under explicit command, to access those blocks in order to transfer their contents, along with their associated addresses, to a local shadow memory or to a remotely located backup computer.

In another embodiment of the invention, the controller is further is further embedded with features that enable it to store the relevant memory addresses onto a main-memory-resident buffer in response to any of the following processor bus operations: read with intent to modify, read with exclusive ownership, cache-line invalidation. This added capability can be used to eliminate the need to flush the processors' caches to establish a checkpoint.

In still another embodiment of the invention, a bit-map memory (or alternatively, an interface to an external bit-map memory), containing one bit for each main-memory block, is integrated into the memory controller. This bit-map memory offers advantages when used with any of the aforementioned enhancements by eliminating the need to copy more than once blocks having the same memory address. A second bit-map memory is also added in a further enhancement in accordance with the present invention. With two bit-map memories, blocks can be copied in the background, while normal processing continues, without the need for a buffer for storing modified data blocks. A bit is set in one of the bit maps whenever the corresponding main memory block address has been stored in the address buffer, and reset in the second bit map, which reflects the buffer state as of the last checkpoint, when the corresponding block has been copied to the shadow memory. Following each checkpoint, the roles of the two bit-maps are reversed. For this embodiment of the invention, the memory controller must also be enhanced so as to delay writes to memory blocks that are scheduled to be copied to shadow memory, as indicated in the relevant bit map, but have not yet been copied, until that copy can be effected. Alternatively, in yet another embodiment of the invention, the two bit-map memories can be used to enable a locally resident shadow memory to be kept in a state reflecting the most recent checkpoint without the need for any main memory blocks whatsoever to be copied from one location to another. In this case, checkpoints can be established simply by flushing the processor caches and reinitializing the bit maps.

In all of these embodiments of the invention, the write-address-buffering technique used for remote checkpointing can also be used in a clustered environment with each computer effectively serving as the unique backup for one other computer in the cluster.

All of the preceding embodiments of the invention require the existence of a shadow memory either locally or in a second computer. Another embodiment of the invention, however, allows local checkpointing to be accomplished without the need for a shadow memory in this case, additional logic is embedded in the memory controller that, on each memory write, delays the write until the memory block being accessed is copied to a main-memory-resident data buffer and its associated address to a main-memory-resident address buffer. Checkpointing is then accomplished simply by flushing the processors' caches. Memory-to-memory copies are needed only in the event of a fault in which event fault recovery entails halting I/O-initiated writes to main memory and copying the buffered data back from the buffer to the corresponding main-memory locations in last-in, first-out order. This enhancement can also be combined with the aforementioned processor bus snooping capability to obviate the need to flush the processor caches and, independently, with the integrated bit map to eliminate the need to intervene in a write to any given memory block more than once during any checkpoint interval.

All of the aforementioned memory controller enhancements enable checkpointing techniques to be realized using otherwise standard hardware platforms running standard operating systems. As a consequence, when these techniques are used in conjunction with the checkpointing and rollback procedures described in U.S. Pat. No. 6,622,263, standard computers can be rendered fault tolerant without requiring the major hardware and software modifications normally associated with fault-tolerant computers. All applications receive the benefit of fault tolerance without having to be modified in any way.

### BRIEF DESCRIPTION OF THE DRAWINGS

The above and further advantages of the invention may be better understood by referring to the following description in conjunction with the accompanying drawings in which:

FIG. 1 is a block schematic diagram of a computer system showing the data and address buffers used by the present invention for checkpointing purposes.

FIG. 2 is a flowchart illustrating the process performed by the memory controller to implement checkpointing in the embodiment of the invention requiring the least added support from the controller.

FIG. 3 is a flowchart illustrating the additional process performed by the memory controller if it is further enhanced to establish checkpoints with minimum external intervention.

FIG. 4 is a flowchart illustrating the process performed by the memory controller in the embodiment of the invention in which buffers are maintained in main memory for both the addresses of all blocks modified since the last checkpoint and for copies of all modified data.

FIG. 5 is a flowchart illustrating a process performed by the memory controller in the previously referred to embodiment of the invention when it is commanded to enter checkpoint mode.

FIG. 5a is a modified version of FIG. 5 showing the checkpoint procedure when a bit-map memory is used to avoid repeated copies of the same block during any single checkpoint interval.

FIG. 6 is flowchart showing the process performed by the memory controller in the embodiment of the invention referred to in the description of FIG. 4 to effect a background copy of all modified data from the buffer to its local shadow memory or to its backup computer.

FIG. 6a is a modified version of FIG. 6 showing the copying procedure when a bit-map memory is used to eliminate the repeated copying of the same physical memory block.

FIG. 7 is a flowchart illustrating the procedure performed by the memory controller in accordance with another aspect of the invention to establish local or remote post-image checkpoints without requiring any memory-resident address or data buffers.

FIG. 8a is a flowchart illustrating the procedure performed by memory controller to copy the modified data blocks, identified using the procedure described in FIG. 7, to their locations in the local shadow memory or to the remote backup computer.

FIG. 8b is a flowchart showing the procedure performed by memory controller to establish a checkpoint when the procedures described in FIGS. 7 and 8a are used to identify and copy the data modified since the last checkpoint.

FIG. 9 is a state diagram showing the states used to label each block in main memory and actions causing transitions between those state when, in accordance with another aspect of the invention, local post-image checkpointing is implemented without either foreground or background memory-to-memory copying.

FIG. 10 is a flowchart showing the procedure executed by the memory controller to implement the state transitions described by the FIG. 9 state diagram.

FIGS. 11a and 11b are flowcharts illustrating the procedures executed by the memory controller to support checkpoint and rollback operations, respectively, when the block-state-labeling method is used to implement local post-image checkpointing.

FIG. 12 is a flowchart showing the steps executed by the memory controller to support pre-image checkpointing.

FIGS. 13a and 13b are flowcharts a flowchart showing the procedures executed by the memory controller to support checkpoint and rollback operations, respectively, in support of pre-image checkpointing.

### DETAILED DESCRIPTION

Several embodiments of the invention are described. All of these embodiments can be implemented with the same enhanced memory controller since the required logic elements are similar for each of them. The different embodiments will be described separately, however, since none of them requires the full complement of enhancements. All of the required enhancements can be easily implemented using standard procedures by anyone knowledgeable in the state of the art and, with the possible exception of those embodiments utilizing integrated memory, represent a small increment in the complexity of the logic already present in existing memory controllers.

The checkpointing strategies implemented by these various embodiments fall into two general categories. The first is referred to as “post-image” checkpointing and requires the existence of a shadow memory located either in the subject computer itself, hereafter called the “primary” or “protected” computer, or in a second computer called the “backup” or “remote” computer. In either case, the shadow memory is updated at the conclusion of each checkpoint interval to reflect the state of the primary computer at that instant in time. If the shadow memory is in a backup computer, a strategy referred to as “remote” checkpointing, the updating process preferably involves first copying any shadow updates to a buffer in the backup and from there to the shadow memory. Handling the updates in this manner guarantees that the shadow does indeed represent a consistent checkpoint state even if the primary fails while the updates are being transferred. If the shadow memory is located in the primary computer, a strategy called “local” checkpointing, such precautions are unnecessary because any failure that would prevent the copying process from being resumed would presumably be fatal in any case. Nevertheless, local checkpointing is attractive since it has been shown to provide a high degree of resilience to faults caused both by software bugs and by hardware transient events and since these two types of events together account for a large majority of computer crashes.

The second checkpointing strategy, “pre-image” checkpointing, does not require a shadow memory and is applicable only to local checkpointing. In this case, the pre-image of any memory block is captured before it is allowed to be modified following a checkpoint and stored in a buffer location along with its address. The recovery process following a fault then entails copying the pre-images, i.e., the memory images that prevailed at the time of the last successful checkpoint, back to their original locations in main memory, thereby restoring the system state that existed at the time of that checkpoint.

It should be noted all system-level checkpointing strategies rely on the assumption that the entire state of the system is captured at each checkpoint. This requires the processors in a multiprocessor system to rendezvous when it is time to establish a checkpoint and for each of them to force its state onto the appropriate memory stack and possibly, depending on the particular embodiment of the invention being implemented, to flush the modified contents of their caches out to main memory. In addition, sufficient state must be retained in main memory to ensure that I/O operations can be restarted correctly following a fault. These requirements can be satisfied through the use of separate I/O processors or through other procedures discussed in detail in U.S. Pat. No. 6,622,263. Similarly, the rollback and recovery procedures discussed in that patent are identical to those assumed here. The focus of this disclosure is on an apparatus and associated procedure for enabling the relevant contents of main memory to be captured at each checkpoint and either retained until the next checkpoint for use, in the event of a fault, to restore memory to its last checkpointed state, or else used to maintain a shadow memory in a state identical with the state of main memory at the time of the most recent checkpoint and, in either case, to do so with minimum modifications to an otherwise standard computer.

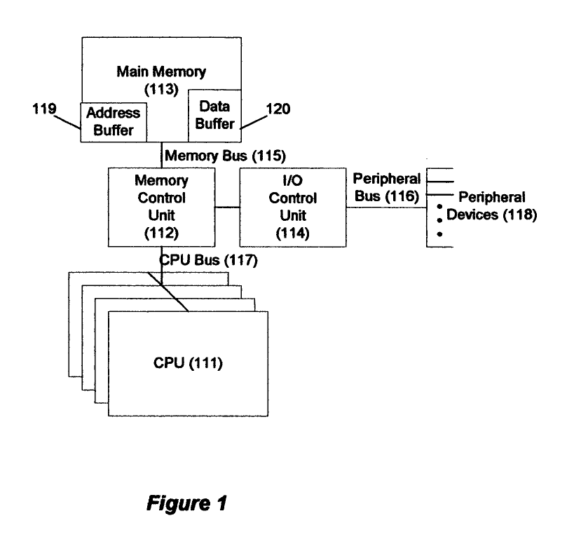

FIG. 1 illustrates a generic computer architecture. The central processing unit (CPU) 111 is typically composed of one or more processors along with their associated registers, cache memories and boot read-only memories (ROMs) (not shown). The CPU communicates with the rest of the system via processor bus 117. The memory control unit 112 connects the processor bus to I/O control unit 114 and to memory bus 115 and through it to main memory 113. The I/O control unit, in turn, connects to one or more peripheral buses 116 and provides the control logic needed to communicate over those buses, typically with disk and tape storage units and with various types of communications controllers. Actual implementations vary. In some cases the CPU and memory controller may be integrated into a single unit; in other cases the memory and I/O control units may be so integrated.

Regardless of how it is implemented, however, the memory control unit 112 contains the logic needed to communicate between main memory and the processors and I/O control units. The memory control unit typically implements the following features that are of particular interest in the present invention:
1. It enforces the relevant cache-coherency protocol. For illustrative purposes, the cache-coherency protocol is assumed here to be the MESI protocol (referring to the modified, exclusive, shared and invalid states of each line held in a processor's cache), but with obvious modifications, alternative protocols could be supported just as readily, including the MOESI protocol and directory-based protocols.
2. It supports direct-memory access (DMA) transfers between main memory and the I/O control unit and between different segments of main memory. It may, in fact, and preferably does, support more than one memory channel so that data can be even more efficiently be transferred from one part of memory to another.

The present disclosure entails no physical modification to this generic architecture other than the memory controller enhancements to be described here. In some embodiments of the invention, it requires a small segment of main memory (113) to be partitioned off and used as an address buffer (119) and in other embodiments, it also requires a second segment of memory to be partitioned as a data buffer (120). In all embodiments, the required memory controller enhancements include the ability to implement certain memory-access and data-transfer sequences to be described, either autonomously after being commanded to do so by one of the processors, or under step-by-step processor control. In support of these activities, the memory controller is also enhanced with a status register containing status bits that can be individually set by the processors to command certain controller operations and read by the processors to determine when these various operations have been completed. Some of these status bits can also be set or reset by the controllers themselves to indicate when certain operations have been completed. These status bits can either be monitored by the processors or, preferably, at the time they are set or reset, cause the memory controller to generate an interrupt to the processors informing them of that fact.

In all of the local checkpoint embodiments of the invention, the memory controller is also enhanced so as to support a “fault mode” of operation. The controller is commanded by one or more processors to enter fault mode immediately upon detection of a fault and remains in fault mode until explicitly commanded to exit that mode of operation. When in fault mode, the controller continues to respond to I/O-initiated memory-accesses in the normal way, using normal hand-shake protocols, but no data written to memory is in fact actually stored in memory and, at least during pre-image restoration, all data read from memory is either read from the same, previously initialized, memory location, regardless of the memory location being addressed or else is simply replaced by a string of zeros. This is to insure that memory is not corrupted with I/O data while it is being restored to the state that existed at the time of the last successfully established checkpoint and that no protected data is inadvertently transmitted to an I/O device before memory restoration is completed and I/O activity can be restarted following recovery.

Finally, since it may be desirable to suppress the enhancements described herein in cases in which checkpointing is not needed or not feasible for other reasons, the enhanced controller features are activated only after a processors sets a “checkpoint-enabled” status bit and are deactivated when this bit is reset.

In the following description of the various embodiments of the invention, the term “memory block” or simply “block” will be used repeatedly. This refers to a fixed-size segment of memory. At minimum, its size is the smallest segment of memory that can be modified in one operation, typically a cache line. It can, however, be as large as a memory page or even larger. The most efficient size is a function of both the bus transfer parameters of the computer in question and of the specific embodiment of concern. The specific block size, however, is not material so far as the details of the various embodiments are concerned.

1) Post-Image Checkpointing Using a Memory-Resident Address Buffer

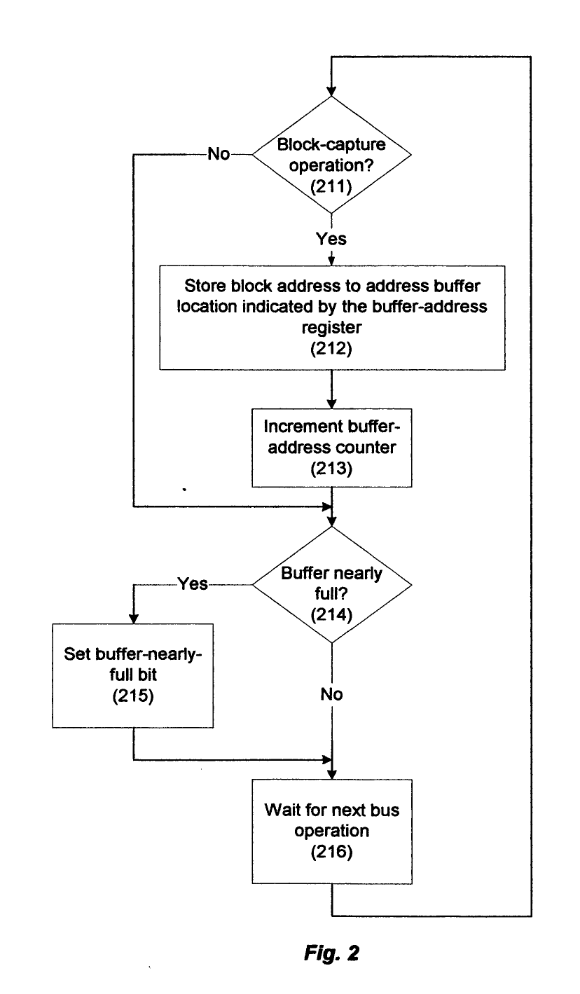

The simplest of the embodiments of the present invention implements a post-image checkpointing strategy and involves only a main-memory resident address buffer (119) and the memory controller enhancements needed to implement the flowchart shown in FIG. 2. To support this embodiment, the memory controller maintains a buffer address register and a checkpoint address register. The most significant bits of both of these registers are identical and may be hardwired, but preferably are kept in a settable base address register so that the buffer can be relocated in main memory to wherever desired. The least significant bits are defined by separate counters. It also contains a status bit that it sets when the buffer address register reaches a preset value, this value preferably also stored in a settable register thereby enabling the controller to accommodate buffers having different capacities and to implement different overflow prevention strategies. This “buffer nearly full” status bit is either monitored by the processors, or, preferably, results in an interrupt being generated to the processors. In either case, when it is detected that this bit is set, the processors immediately enter checkpoint mode.

In this embodiment, as well as in all subsequent post-image checkpointing embodiments, the controller may implement either only local or only remote checkpointing, or if designed to implement both (i.e., to support both memory-to-memory and memory-to-I/O transfers of backup data) it must contain a status bit through which either the checkpointing software or a hardwired input pin can inform it which strategy is being implemented.

In accordance with the flowchart in FIG. 2, the memory controller, in addition to its normal functions, monitors the processor and I/O buses for “block-capture” operations. In this first embodiment of the invention, these block-capture operations are simply write operations to main memory initiated by any processor or I/O device. When a write operation is detected (211), the memory controller appends the associated block address onto the buffer at the location indicated by the buffer address register (212). It then increments the buffer address counter (213) and checks to determine if the buffer is reaching capacity (214). If it is, it sets the “buffer-nearly-full” status bit (215). It then suspends this activity and waits for the next bus operation (216).

When it is time to establish a checkpoint, the computer's processors rendezvous in the usual manner; each processor flushes its internal state and the contents of all its modified cache lines out to main memory. When they have completed flushing their caches, they again rendezvous and a designated processor sends a command to the memory controller placing it in checkpoint mode. The processors then cease normal program execution and either periodically poll a status register in the memory controller to determine when it has exited checkpoint mode or, alternatively, await an interrupt from the controller informing them of that fact, before resuming normal execution. Upon exiting checkpoint mode in the case of remote checkpointing, either one of the local processors or the controller itself sends a checkpoint-complete message to the backup computer so that it can recognize a boundary in its buffer indicating that all blocks received prior to this boundary can now be moved to the appropriate locations in the backup's shadow memory. Since, in some implementations, it may be possible in rare circumstances for the backup computer to experience a buffer overflow, caused by data generated during the current checkpoint interval arriving faster than data buffered during the previous checkpoint can be transferred to the shadow memory, standard flow-control protocols are used in such cases to halt the copying process and leaving the memory controller in checkpoint mode until the buffer is able to accept new data. To prevent a failure in the backup computer from causing excessive delays, processors in the protected computer monitor the amount of time spent in checkpoint mode and reset the checkpoint-enable status bit causing the controller to exit checkpoint mode and to cease further checkpoint operations. Alternatively, if the remote buffer does overflow, the backup can signal the protected computer to transmit the contents of its entire memory to the backup shadow memory using standard protocols for remote checkpointing resynchronization.

The decision to enter checkpoint mode is governed by a number of factors (e.g., elapsed time since the last checkpoint, pended synchronous I/O events, etc.) one of which may be the fact that the address buffer is approaching capacity. To prevent buffer overflow, the memory controller may either make the buffer-address register available to be read by the processors or, alternatively, may generate an interrupt when the buffer reaches a pre-defined fraction of its capacity. In the latter case, the fraction precipitating the interrupt is preferably settable by the checkpoint software since different applications may require different strategies.

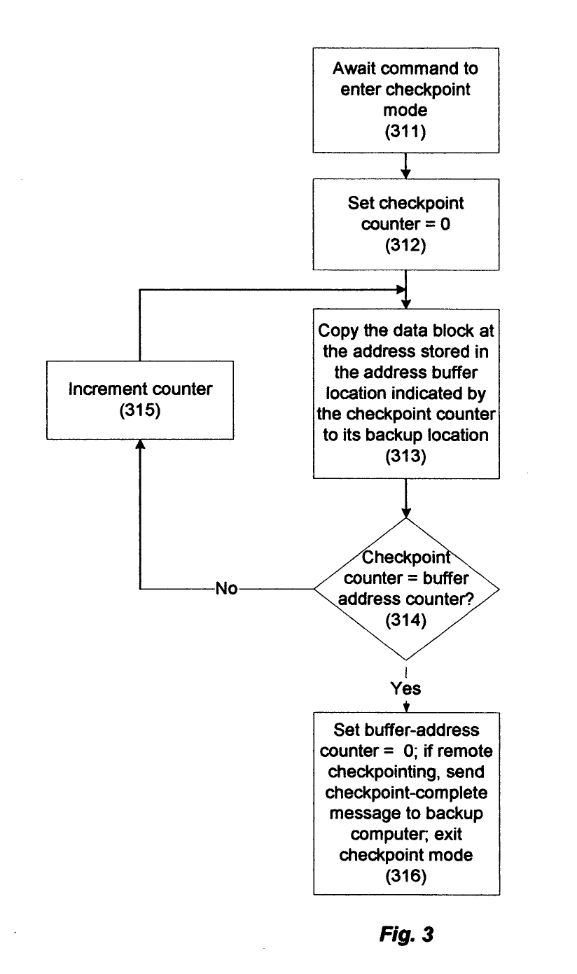

The controller operations in checkpoint mode are shown in FIG. 3. The controller enters checkpoint mode upon command from a processor (311). It sets the checkpoint counter to zero (312) and begins copying, in first-in, first-out (FIFO) order, the contents of the blocks corresponding to the buffered addresses, stored in the address buffer at the successive locations defined by the checkpoint address register, to their corresponding locations in a local shadow memory, or, in the case of a backup computer, along with their associated addresses to the I/O controller for transfer to a remote buffer (313). After each such copy operation, the controller compares the checkpoint counter with the buffer address counter (314). If they don't match, it increments the checkpoint counter (315) and copies the block pointed to in the buffer at the incremented address. If they do match, all relevant memory blocks have been copied and the memory controller resets the buffer address counter to zero and exits checkpoint mode, either by setting a status bit that can be read by the processors or by generating an interrupt to them (316). If there is a buffer-nearly-full bit, the controller also resets it. Again, for remote checkpointing, the controller also signals the backup computer that the checkpoint has been completed.

While the operations in the previous paragraph are described as though the controller itself implements the control functions needed to carry them out, it should be apparent that they can equally well be implemented by one or more processors reading the successive addresses from the address buffer and effecting the copy through ordinary read and store operations. Implementing these functions in the memory controller, however, adds only modest complexity to the controller and can significantly reduce the amount of time needed to effect the data transfer.

2) Post-Image Checkpointing Using Expanded “Block-Capture” Operation

In a second embodiment of the invention, the definition of “block-capture operation” is expanded to include, in addition to write operations, any operation that indicates the possibility of a deferred write to main memory, e.g., in the case of the MESI cache-coherency protocol, read with exclusive ownership or read with intent to modify and cache-line invalidate operations. With this change in definition and with the proviso that all data must be recognized as shared data, both the normal-mode operation shown in FIG. 2 and the checkpoint-mode operation shown in FIG. 3 proceed exactly as just described. While the copying operation previously did not depend on bus snooping, however, copying in this case is preferably done with bus snooping enabled. If this is done, the processors can omit the cache-flushing operation following the checkpoint rendezvous and instead rely on the cache coherency protocol to guarantee that the most recently modified blocks are copied. Consequently, the processors, after saving their internal states, can immediately command the memory controller to enter checkpoint mode.

3) Post-Image Checkpointing Using I/O-Resident Address and Data Buffers

The memory-resident buffers required with the first of the two previously described implementations can be replaced with buffers in an external I/O device dedicated, or partially dedicated, to this purpose. If the address and data associated with the write operation are both simultaneously stored to an I/O buffer, and if the checkpoints are to be established in a remote computer, the previously described memory controller functions can be relegated instead to the I/O device itself. On any memory write, the memory controller also simultaneously relays the address and associated data to the I/O device. If the controller-to-I/O transfer rate is less than the controller-to-memory rate, however, the memory controller must be able to delay successive write operations to accommodate the reduced I/O rate.

The I/O device transfers the captured addresses and data to address and data buffers in the corresponding I/O device in the backup. This I/O device, in turn, uses standard direct-memory-access (DMA) techniques to transfer the data into the backup's main memory once it has been sent a command indicating that a checkpoint has been established. The need to halt processing while the copy is taking place can also be eliminated if the buffers in the I/O device are designed to accept new post-checkpoint data while also transferring the pre-check point data to the backup computer. Checkpointing occurs as previously described but once the processors have flushed their caches and signaled the I/O device that the checkpoint has been established, normal processing can resume. To prevent a buffer overflow in the I/O device, either: 1) the I/O device must have a readable status register by which the processors can monitor how nearly the buffers are filled to capacity; 2) the I/O device must be designed to generate a processor-visible interrupt indicating that capacity is being approached; or 3) the memory controller must implement either of these preceding two functions, as previously described.

The need for cache flushing can be eliminated in this case as well if all operations that can result in a deferred write to main memory are included in the definition of “block-capture operations”. Since the memory locations corresponding to the captured addresses must all be read following each checkpoint using this approach, however, the checkpoint operations are essentially identical, regardless of whether they are implemented in the memory controller or in the I/O device.

4) Post-Image Checkpointing Using Two Memory-Resident Address and Two Memory-Resident Data Buffers

Another embodiment of the invention allows the data to be copied in background mode simultaneously with normal processing and without requiring a dedicated I/O device of the sort required for the previous implementation. To accomplish this, three more main-memory buffers are defined, a second address buffer (119) and two data buffers (120), with each data buffer entry equal in size to a memory block. To support these additional buffers, the memory controller contains a total of four hardwired or, preferably, settable, base address registers, each pointing to the initial location of one of the buffers, two counters, an end-count register and a three additional bits in its status register. Subsequent addresses are determined, as before, by concatenating the contents of these base address registers with the contents of a counter. One counter is used for one address and data buffer pair and the second used for the other. Since a data block is generally larger than an address, the counter contents are shifted to the left by the amount needed to account for this difference before being concatenated with the remainder of the address. The end-count register is used to hold the incremented content of the buffer address counter at each checkpoint. The three status bits, called the “current-buffer pointer”, the checkpoint-complete bit and the “checkpoint-copy-complete” bit, enable the controller to determine, among other things, which set of buffers is to be used for current write operations and which for copy operations. In particular, the exclusive-nor of the bits in the first and third of these status bits determines which set of buffers is currently being copied to the shadow location. As before, a fourth status bit, either hardwired or settable by software, informs controllers designed to support both local and remote checkpointing whether the shadow memory is located locally or in a backup computer.

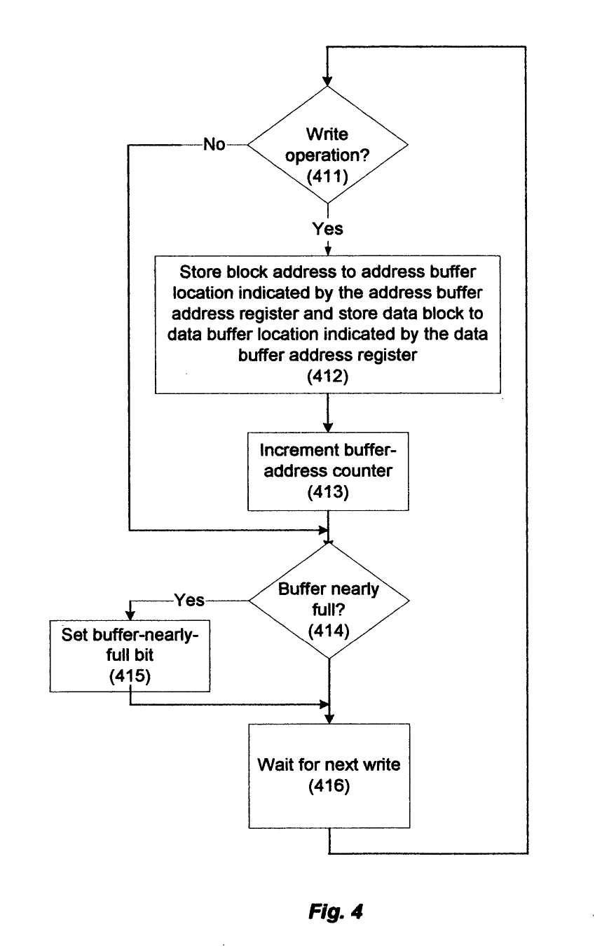

As shown in FIG. 4, the buffers are filled using virtually the same procedure as before. Only processor- and I/O-initiated writes to memory trigger a buffer operation in this embodiment (411). In this case, however, in addition to writing its address to the data buffer, the memory controller also writes the block itself to the data buffer (412). The buffer address counter is incremented (413), the buffer-nearly-full test is made (414), the status bit is set as appropriate (415) and the procedure then waits for the next write operation (416) exactly as before. If the memory controller supports two independent memory buses, the data buffer can be partitioned so that writes over one bus are buffered using the opposite bus, thereby enabling the two operations to be carried on simultaneously, but this is not a requirement of the invention.

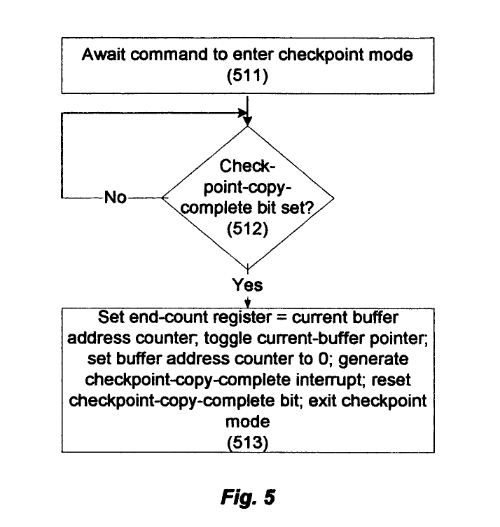

Checkpointing is initiated as before, but is accomplished without having to wait for the modified data blocks to be copied. As shown in FIG. 5, after being sent a command to enter checkpoint mode (511), the memory controller first checks to determine if the checkpoint-copy-complete bit has been set (512) indicating that all of the memory blocks associated with the previous checkpoint have been copied to their shadow locations. The controller does not proceed with the checkpoint operation until this bit has been set. Once it is set, the controller simply copies the contents of the current buffer address counter into the end-count register, thereby defining the number of blocks in the current data buffer that have to be copied to their shadow locations, toggles the current buffer pointer and resets the buffer address counter so that the alternate buffer can begin accepting new blocks while the one just loaded can be copied, resets the checkpoint-copy-complete bit and exits checkpoint mode (513). As before, the processors are informed that the controller has exited checkpoint mode, either through an interrupt (as indicated in step 513) or alternatively by polling a controller status bit. If the latter procedure is used, the checkpoint-copy-complete bit must be reset by one of the processors after all processors have detected that it was set. Normal processing can resume immediately after this bit is reset.

In a slight variation on this embodiment, the two address and two data buffers can be combined into one circular buffer with one counter (the buffer-address counter) indicating the next available buffer location to which addresses and data are to be stored and the second (the checkpoint counter) the next buffer location from which addresses and data are to be copied to the backup location. In this case, the two counters point to different locations in the same address buffer and different locations in the same data buffer. The response to a write operation is again that depicted in FIG. 4. The buffer-nearly-full test (414) here entails comparing the buffer-address counter with the checkpoint counter and setting the status bit when the former reaches to within a predetermined distance from the latter. Since the unified buffer is a circular buffer (i.e., since the buffer-address and checkpoint counters both reset to zero when incremented past their maximum values) “distance” here is defined as the number of times the buffer-address counter must be incremented before it reaches the current state of the checkpoint counter. The checkpoint mode procedure of FIG. 5 is the same for this embodiment as for the one using two separate buffers except that, again since this embodiment uses a unified, circular buffer, the current buffer pointer is irrelevant and need not be toggled (or even exist) in step 513 and the buffer-address counter does not have to be reset.

When the shadow memory resides in a backup computer, no I/O event pended on checkpoint completion, however, can be released until all memory blocks that were modified during the interval immediately preceding that checkpoint have been copied to the remote buffer. Before releasing those I/O operations, therefore, the processors wait for the checkpoint-copy-complete status bit to be set and, as with the checkpoint mode status bit, are informed of that event either by polling or, preferably, through an interrupt.

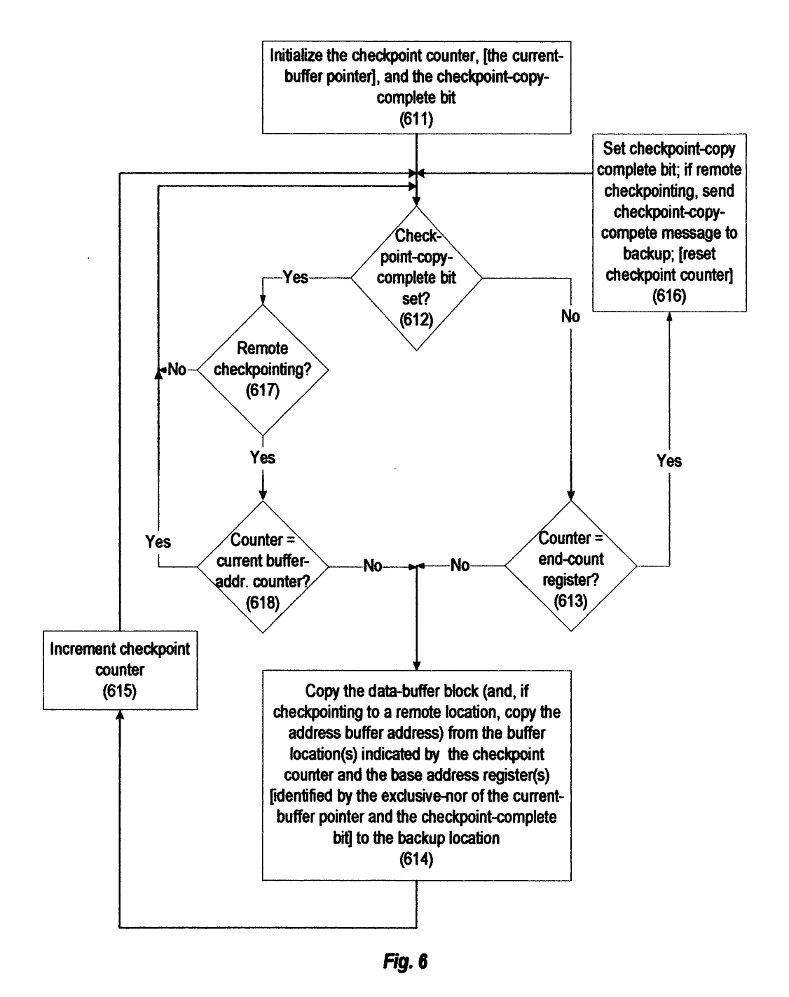

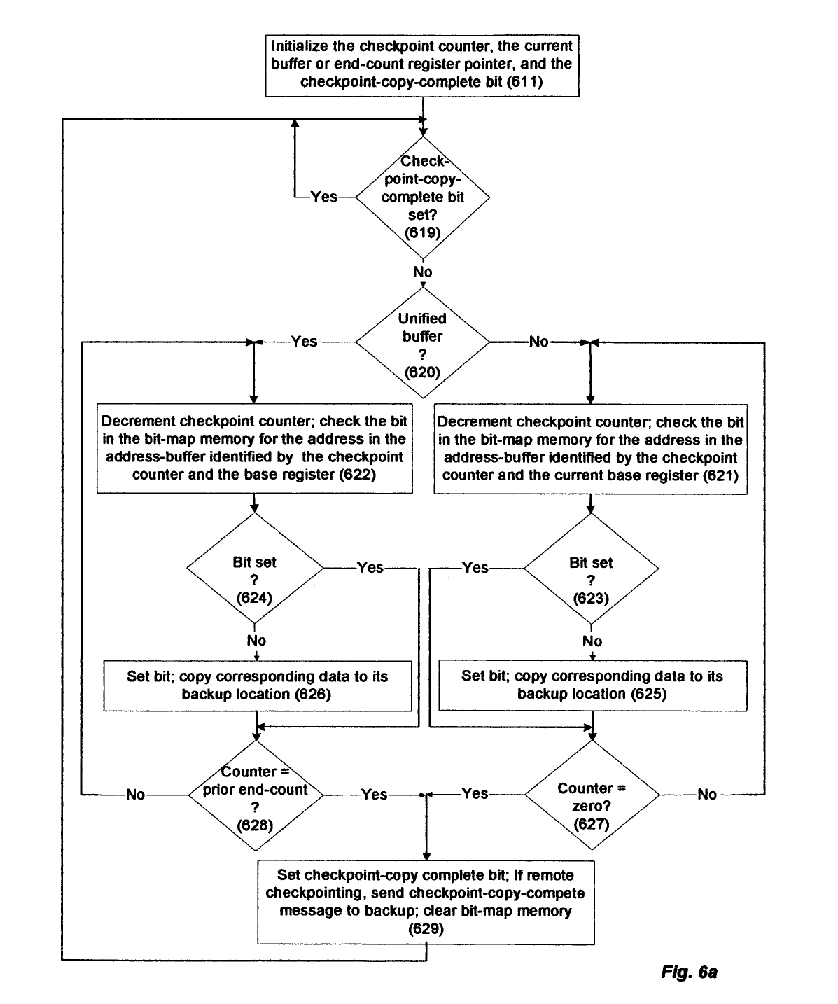

Once the controller resets the checkpoint-copy-complete bit, the buffer copy routine can immediately begin copying the buffer currently being filled. This is illustrated in the flowchart in FIG. 6, which shows the buffer copying routine for both the separate and the unified buffer implementations. In the latter case, those operations contained between square brackets can be omitted. Again, the copy routine is preferably also implemented by the memory controller. Following startup initialization (611), this routine monitors the checkpoint-copy-complete bit (612) and branches depending upon whether it is set, indicating that all the data blocks that were modified during the last checkpoint interval have been copied, or not set. If it is not set, the copying routine compares the contents of the checkpoint counter with those of the end-count register which represent the next buffer location that would have been written to had the checkpoint operation not intervened (613). If the two match, indicating all such blocks have been copied, the routine sets the checkpoint-copy-complete bit, and, if checkpointing to a backup computer, sends a checkpoint-copy-complete message to that computer (616). In the non-unified buffer embodiment, the checkpoint counter is also reset. The routine then again checks the checkpoint-copy-complete bit to determine the next action. If the checkpoint counter and the end-count register do not match, there are more blocks to be copied so the next data block, and, in the case of remote checkpointing, the associated address, are copied to the local shadow memory or to the backup computer's resident buffer (614). In the separate buffer embodiment, the buffer from which the block is copied is determined by the exclusive-nor of the checkpoint-copy-complete bit and the current-buffer bit. Since, for local checkpointing, copying takes place only when the checkpoint-copy-complete bit is not set, the buffer being copied in this case is always the opposite of the one currently being filled.

If the checkpoint-copy-complete bit is set (612) and remote checkpointing is in effect (617), the copy operation can continue from the buffer currently being filled since the data blocks and addresses are copied to a buffer in the backup computer and are not moved to the backup's shadow memory until a checkpoint is declared by the protected computer. If the protected computer fails before the next checkpoint, the contents of remote buffer that were copied to it after the last declared checkpoint are simply ignored. Thus, if the contents of the checkpoint counter and the current address counter are not equal, i.e., if there are modified blocks that have not yet been transferred to the remote buffer (618), the corresponding block identified by the checkpoint counter can be copied as previously described (614). In this case, since the checkpoint-copy-complete bit is set, the block is copied from the buffer currently being filled. The primary advantages of doing this are the reduction in the size of the local buffers and, since it reduces the interval between the time the protected computer establishes a checkpoint and the time the checkpoint-copy-complete bit is set, a potentially substantial reduction in the delay before checkpoint-pended I/O can be released. In the vast majority of cases, blocks will be copied immediately after they are modified, thereby reducing the time needed to establish a checkpoint to a minimum.

It should be noted that, if the memory controller is implemented to carry out these copying operations autonomously, this same controller functionality can be used in the backup computer enabling it to support the concurrent loading of one buffer pair through DMA operations from the designated I/O device while it is moving data from the second data buffer to the addresses specified in its associated address buffer. In this case, the status bit used to distinguish between remote and local checkpointing is set to “local”. The I/O device, upon receipt of a checkpoint-copy-complete message, generates a processor-visible interrupt and sends data indicating the number of blocks that have been transferred since the last checkpoint-copy-complete message. The processor then loads this count into the memory controller's end-count register and resets its checkpoint-copy-complete bit and toggles its base-address-register pointer. When operating thus in the backup computer, the memory controller copy routine remains as shown in FIG. 6. The checkpoint-copy-complete message (616) is used to inform the primary computer that the shadow memory has been synchronized with the last checkpoint and hence any pended I/O operations can be released.

Further, it should be apparent that a memory controller can be implemented to provide the functionality needed for it to implement concurrently any combination of the operations described in the previous paragraphs, and, in particular, operations needed both to enable a computer to accept checkpoint data from a remote computer and to transmit its own checkpoint data to a remote backup computer. The number of registers and counters it would have to support, of course, has to equal the sum of those needed for each role. For example, if it is to support both roles simultaneously using two address registers and two data buffers for each role, it would have to support four address and four data registers. Other combinations, e.g., using two address and two data registers to support checkpointing its own data in combination with an I/O device that simultaneously implements the transfer of a remote computer's checkpoint data into its shadow memory, are also possible as are combinations of any of the previously described implementations with any of those that follow.

5) Post-Image Checkpointing Using a Bit-Map Memory

It should also be noted that the copying time resulting from any of the aforementioned embodiments of the invention using memory-resident buffers could be reduced somewhat by integrating the address buffers into the controller itself, thereby saving one external memory access on each transfer. A generally more efficient use of internal memory is possible, however, by integrating into the controller a memory segment containing a single bit for each memory block in physical memory. In all the previously described post-image checkpointing embodiments of the invention, memory blocks are copied to their backup locations in first-in, first-out (FIFO) fashion. That is, the first blocks to be modified are the first copied. This ensures that, in the event of multiple modifications to a given block, the last modification is the one that survives, overwriting any earlier modifications of that same block in the copying process. But the need to copy any given block more than once can be eliminated entirely by copying, instead, in last-in, first-out (LIFO) order and by setting a bit in the controller's integrated memory corresponding to each physical memory block copied. Prior to any copy, the controller then checks this bit-map to determine if the block has already been copied and, if it has, skipping to the next (in this case, previous) address on the queue of addresses to be copied. Once all blocks have been copied, the controller's memory is cleared. The copying time in all of the previously described embodiments can be reduced somewhat using this procedure.

When this embodiment is used, however, the checkpoint procedure needs to be modified slightly as shown in FIG. 5a. Steps 511 and 512 are as previously described, but step 513 is replaced with the following: First the appropriate status bit (either settable or hardwired) is checked (514) to determine if separate buffers or a circular buffer is being implemented. In the former case, the contents of the current buffer address register are loaded into the end-count register, the current buffer address register is then set to zero and the buffer pointer is toggled (515). In the latter case, a second end-count register is required along with a single bit that is used as a pointer to select which is to be used as the current end-count register and which as the prior end-count register. At the time of a checkpoint, the current end-count register and the checkpoint counter are both loaded with the contents of the current address counter and the end-count-register pointer bit is toggled (516) so that the previous current end-count register becomes the new prior end-count register. In either event, the checkpoint operation is complete and the controller generates an interrupt informing the processors of that fact and resets the checkpoint-copy complete bit indicating that more checkpointed data is ready to be copied (517).

In addition, the copying routine shown in FIG. 6 is replaced by that shown in FIG. 6a. Following initialization (611), the routine monitors the checkpoint copy complete (619). As soon as it is reset, it then branches (620), depending upon whether two separate memory-resident buffers are being used or if a unified, circular buffer is used instead. (Clearly, if only one of these options is supported, the branch point can be eliminated and only one of the branches implemented in the routine.) If two buffers are used (620), then the checkpoint counter is decremented and the bit in the bit-map memory at the address in the address buffer location identified by the checkpoint counter concatenated with the current base address register (as indicated by the current-buffer pointer), is checked (621). If it is set (623), a later version of the corresponding block has already been copied; if not, the bit is set and the block is copied from the associated data buffer location (625). For remote checkpointing, both the data block and its associated address are sent to the shadow buffer in the backup computer. The checkpoint counter is then tested (627). If it is equal to zero, all relevant blocks have been copied; the routine then sets the checkpoint-copy-complete bit, clears the bit-map memory and, in the remote checkpointing case, sends a copy-complete message to the remote backup (629) and then again waits for the checkpoint-copy-complete bit to be reset (619). Alternatively, if the memory controller is designed to set the corresponding bit in the bit-map memory whenever a new address is stored into the address buffer, then the copy routine can reset that bit when the data is transferred and abort the transfer if it is already reset. This avoids the need to clear the bit-map memory in set 629 at the cost of an additional operation on every address capture.

If a unified buffer is implemented, the only difference is that only one base address register is used in step (622) and the checkpoint counter test involves comparing it with the contents of the prior-boundary register (628), a match indicating that the most recent version of all relevant blocks have now been copied.

Note that, in contrast to the copy routine described in FIG. 6, blocks modified since the most recent checkpoint are not copied using this routine until the next checkpoint is declared. Consequently, all modified blocks are copied only once. The two copy routines can be combined, thereby allowing blocks modified following the last checkpoint to be copied even when a bit-map memory is used. The pre-checkpoint blocks are copied in FIFO order, however, while post-checkpoint blocks continue to be copied in LIFO order. Moreover, the corresponding bit in the bit-map memory is not set when post-checkpoint blocks are copied, since further modifications of those same blocks are still possible. Combining the features of these two routines potentially reduces the time it takes to synchronize a remote shadow memory with the most recent checkpointed state at the cost of nullifying to some degree the reduction in the number of blocks that have to be copied through the use of a bit-map memory.

6) Post-Image Checkpointing Using Two Bit-Map Memories

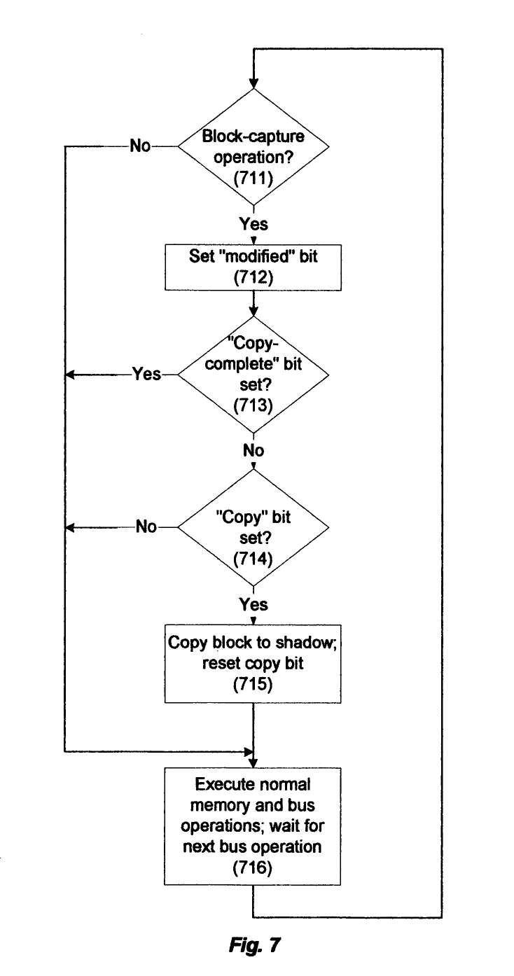

An alternative use of two integrated (or accessible external) single-bit-wide memories is possible if one is used as a bit-map showing which memory blocks have been modified since the last checkpoint and the second used to show which of the blocks that were modified prior to the last checkpoint have been copied to a local shadow memory or remote computer. In this case, background copying can be supported without any main-memory-resident address or data buffers. The memory controller routine needed to exploit this enhancement is shown in FIG. 7. One of the two bit-maps is designated the “modified map” and the other the “copy map”. Either of the two physical single-bit memories assumes either role at different times. The controller contains two single-bit pointers, one indicating which memory is the copy map and the other which memory is the modified map, which may or may not be the same as the copy map. It also contains a “copy-complete” bit that is set by the copy routine when it has completed copying all blocks modified prior to the last checkpoint.

On any memory access the routine first checks to see if it is a block-capture operation (711), with the term “block-capture” as previously defined (i.e., either only a write operation or any of the operations that will potentially result in the modification of the block in question, including, of course write operations). If it is not, the access is handled in the normal way (716). If it is, the controller sets the bit in the modified map corresponding to the addressed block (712) and checks whether the copy-complete bit has been set (713). If it has, the access is again handled in the normal way; if it is not, the routine checks the corresponding bit in the copy map (714). If the latter bit is set, then, depending on whether local or remote checkpointing is being supported, the controller copies the current contents of the block to either the local shadow or the block contents and its associated address to the remote shadow buffer and then resets the copy bit (715). Following that, or if the copy bit is not set, it again handles the access in the normal way (716).

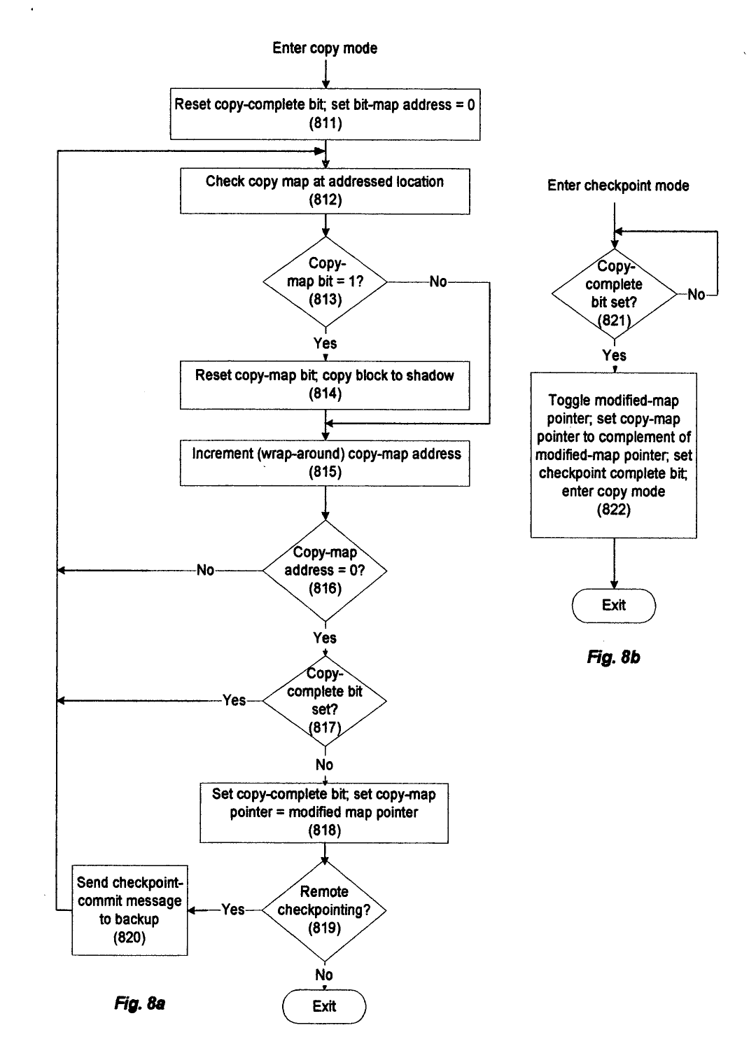

A flowchart of the copying routine implemented by the memory controller to support this embodiment of the invention is shown in FIG. 8a. The controller is commanded to enter copy mode immediately after a new checkpoint has been established. It first resets a status bit called the “copy-complete” bit and resets a register containing the address used by this routine to access the copy map (811). It then checks the bit in the copy map location pointed to by this register (812) and, if the bit is set (813) copies the corresponding block to the local shadow or remote shadow buffer (814). In either case, it then increments the copy-map address register (815). If the address prior to this was the largest address of the copy map, the register wraps back to the all-zeros address. The address is then tested (816) to determine if it is the all-zeros address. If it is not, the next copy-map bit is checked and the process continues as before. If it is, the controller routine then checks the copy-complete bit (817). If it is not set, the controller sets it, indicating that all of the blocks modified at the time the last checkpoint was established have now been copied, and toggles the copy-map pointer so that it now points to the opposite single-bit memory (818). If remote checkpointing is being implemented (819), the data and addresses are copied to a remote buffer rather than directly into the shadow memory so copying can continue once the remote computer has been informed that all the data associated with the last checkpoint has been transferred (820).

The controller routine needed to commit a checkpoint in this embodiment is depicted in the flowchart in FIG. 8b. The controller first checks the copy-complete bit (821) to determine if the copy routine has copied all of the data associated with the previous checkpoint and, if it has not been set, waits until it is. It then toggles the modified-map pointer so that the alternate bit-map is used to record the memory blocks that are modified during the new checkpoint interval, sets the copy-map pointer to the complement of the new modified-map pointer, which may have already been done during the copy routine, sets the checkpoint complete bit and restarts the copy routine (822).

Note that this last action restarts the scan for modified, but not yet copied, memory blocks even though, in the case of remote checkpointing many of the modified blocks may already have been copied. Since the main memory will, in general, contain a large number of blocks and since the vast majority of those blocks will not have been modified since the last checkpoint, it is preferable, with this embodiment of the invention, for a number, say 32 or 64, of copy-map bits to be scanned simultaneously. If all bits are zero, as will typically be the case, the copy routine can immediately proceed to the next set without having to test each bit individually.

7) Checkpointing Using a Block-State Memory

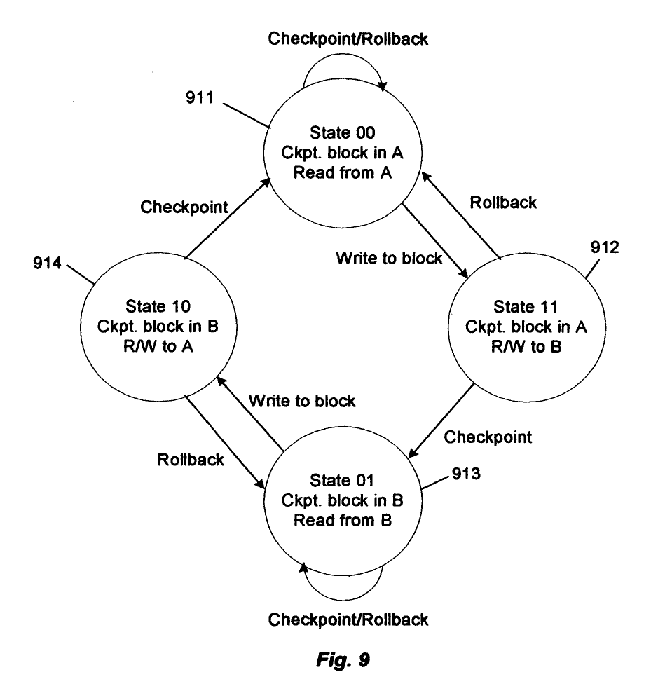

Even greater efficiencies can be realized with a bit-map memory containing two bits for each memory block in physical memory when checkpointing is directed to a local shadow memory. In this case, the need for memory-to-memory copies for checkpointing purposes can be eliminated entirely if, on each memory access, the controller checks the state of its internal memory location corresponding to the block being accessed and directs the access to either of two main memory locations in accordance with that state. In this embodiment, the computer's primary and shadow memories are no longer fixed physical locations; rather, either of two physical locations can be the primary location at any given time while the other retains the state of the system that existed at the time of the last checkpoint. The algorithm used by the controller to determine which is which is shown in FIG. 9. Each main memory block directed to one of the two predefined locations in main memory, designated in FIG. 9 as “block A” or “block B”, as determined by that algorithm. The most straightforward procedure for directing the access is for the controller to toggle the most-significant bit of the memory address. For convenience of exposition, it will be assumed here that the most-significant address bit is set by the controller to “0” for block A and to “1” for block B. If a block is in state 00 (911), in particular, the controller addresses all reads from that block to block A and block A is also the checkpointed version of that block should a rollback be necessary before the next checkpoint is established. The block remains in state 00 until a write access is attempted, in which case it transitions to state 11 (912). The write precipitating the transition is directed to block B as are all subsequent accesses, both read and write, either until the next checkpoint is established, in which case the state associated with that block transitions to state 01 (913), or until a rollback is initiated, in which case the state is reset to state 00. In state 01, all read accesses are directed to block B. The block remains in that state until the first write access causes it to transition to state 10 (914); the write causing the transition and all further accesses, prior to the next checkpoint or rollback, are then directed to block B. Upon the establishment of the next checkpoint, the block transitions to state 00 or, in the event of a rollback, it is returned to state 01.

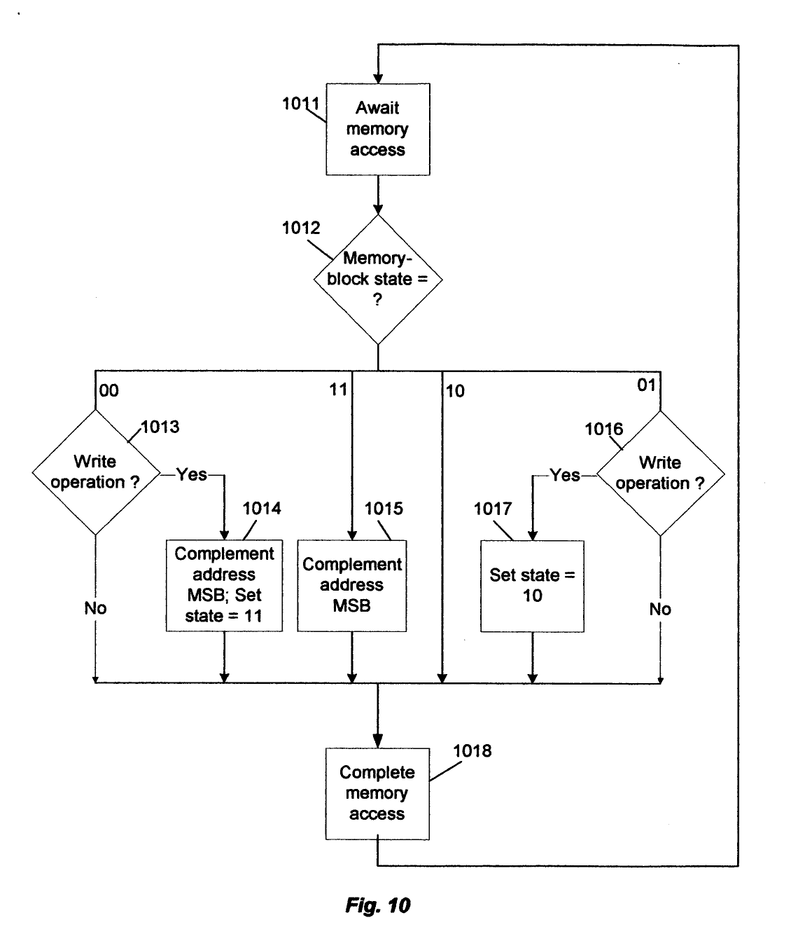

To realize this embodiment, the memory controller implements the flowchart shown in FIG. 10. On each main memory access (1011), the controller checks the state associated with the memory block being accessed (1012). If it is in state 00 or 01, the controller then determines if the memory access is a write operation (1013 and 1016, respectively). If the block is in state 00 when the write access is initiated, the controller changes the state to 11 and complements the most significant bit of the address of the block being accessed (1014); if it is in state 01, it changes the state to 10 and leaves the address unmodified (1017). If the accessed block is in either state 11 or 10, the controller leaves the state unchanged. In the former case, it then complements the most significant address bit (1015); in the latter case, it leaves the address unmodified. In all cases, it then lets the access proceed in the normal manner using the address thus generated (1018).

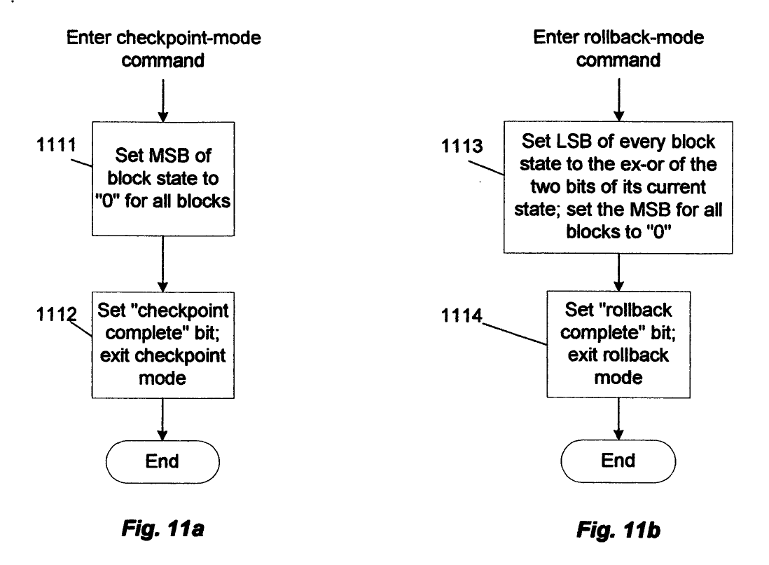

When a checkpoint is declared, the controller is sent a command to enter into checkpoint mode following which it sets the checkpoint-mode status bit and executes the routine shown in the flowchart in FIG. 11a. In particular, it sets the more significant of the two state bits of each block to “0” (1111), preferably by using a master reset on the relevant column of the state memory. It then resets the checkpoint mode status bit (1112), which preferably generates a processor interrupt but, alternatively, may be monitored by the processors following the issuance of the “enter checkpoint mode” command, and exits checkpoint mode.

When it is necessary to institute a rollback, the controller executes the routine shown in FIG. 11b. On receiving a command to enter rollback mode and setting the “rollback-mode” status bit, the controller modifies the state of each memory block as follows: blocks in state 11 are changed to state 00; those in state 10 are changed to 01; the states of blocks in either of the other two states are left unchanged. The method for accomplishing this shown in FIG. 11b (1113) is to change the less significant bit of each memory state to the exclusive-or of the two state bits and to then complement the more significant bit, but other methods for accomplishing the same transition are obviously possible. Once this has been accomplished, the controller resets the rollback-mode status bit and exits rollback mode (1114).

Note that rollback mode and fault mode are two different things, the former subsumed by the latter. As previously stated, the controller is commanded to enter fault mode immediately on the discovery of a fault and remains in that mode until recovery is completed, handling I/O accesses as described above. Rollback mode in this instance simply forces the memory controller to execute the rollback routine depicted in the flowchart in FIG. 11.

8) Pre-Image Checkpointing

Memory-controller enhancements of the sort described in the previous paragraphs can also be used to implement pre-image checkpointing. In this case, a partition of main memory is used to buffer the pre-images of any blocks that are modified following the establishment of each checkpoint and a second partition used to store the physical addresses of those blocks. Following each checkpoint, the buffers are effectively cleared by zeroing out the buffer counter and the process starts anew. If a fault is detected, the contents of the data buffer accumulated since the last checkpoint are copied back to the locations indicated by the corresponding addresses in the address buffer.

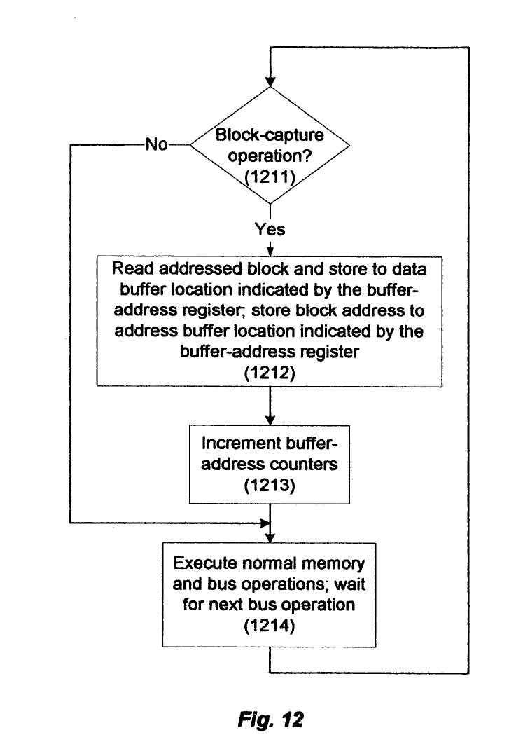

The procedure implemented by the memory controller to accomplish this is shown in FIG. 12. On each block-capture operation (1211) the controller first reads the memory block so indicated and stores the data thus read in the data buffer and the associated address in the address buffer (1212). As before, a block-capture operation can be either a memory-write operation or, in addition to write operations, any operation that indicates the possibility of a deferred write to main memory. In the former case, establishing a checkpoint first involves flushing the contents of all processor caches back to main memory before commanding the controller to enter checkpoint mode. In the latter case, no cache flushing is required.

Once the data block and associated address are copied to the buffers, the buffer addresses are both incremented to point to the next available location (1213) and the controller then carries on in the normal way (1214) executing the standard memory access procedures and bus protocols. For purposes discussion, it is assumed that the buffer addresses are generated as previously described using one counter, here called the checkpoint counter, concatenated with either hard-wired or settable base registers.

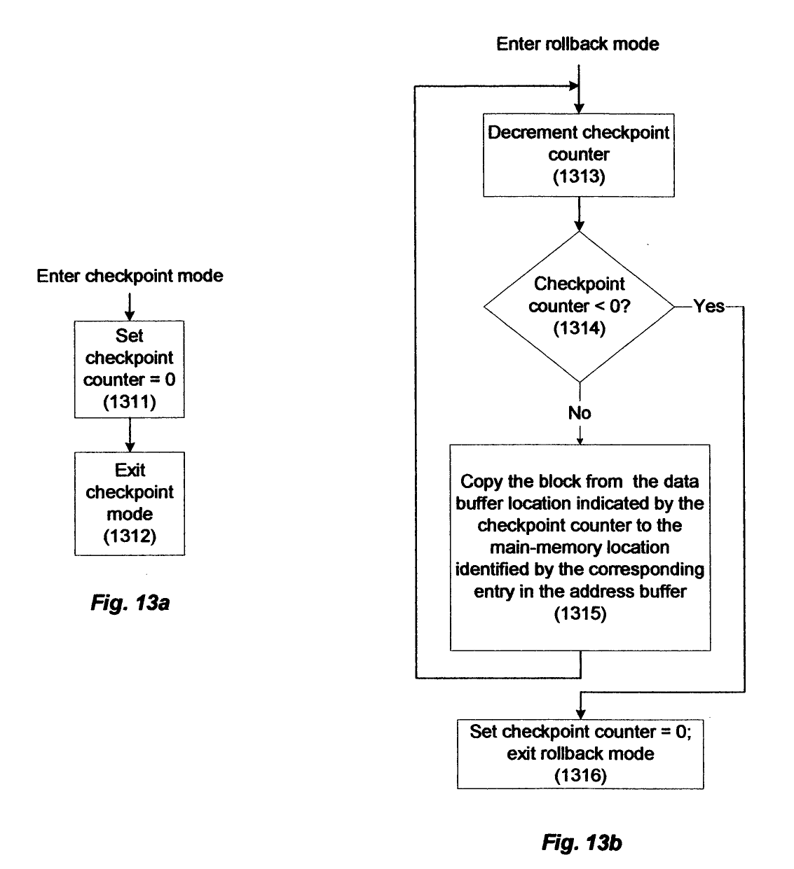

To effect a checkpoint, the processors rendezvous in the usual way, save their states and, if required, the flush their caches, then command the memory controller to enter checkpoint mode (FIG. 13a). In this case, the controller's response consists solely of resetting the checkpoint counter (1311) and immediately exiting checkpoint mode (1312).

Following a fault, the controller is, as always, first put in fault mode and then into rollback mode. In rollback mode, it executes the procedure shown in FIG. 13b. It first decrements the checkpoint counter, then checks its state (1313). If it was in the all-zeros state before being decremented (1314), no blocks have been copied to the buffer since the last checkpoint and there is nothing more for it to do, so it simply sets the checkpoint counter back to zero and exits rollback mode (1316). If the counter contents are greater than or equal to zero, the controller copies the contents of the data stored at the buffer location pointed to by the counter to the memory location indicated by the corresponding location in the address buffer (1315). It then again decrements the counter (1313) and copies the next block to its indicated location in main memory. It continues this procedure, copying from the buffer in LIFO order, thereby restoring main memory to the state that prevailed at the time of the last completed checkpoint.

As with post-mage buffering, the possibility of copying to the same main-memory location more than once can be eliminated by implementing a small memory having one bit for every physical block in main memory. In this case, the corresponding bit is inspected before any block is copied to the buffer (cf. FIG. 12, step 1212). If it is set, no copy is necessary; otherwise, the copy takes place and the bit is then set. This eliminates unnecessary copying both during normal operation and on a rollback.

What is claimed is:

1. Apparatus enabling an otherwise standard computer system to support system-level checkpointing, such apparatus consisting of a conventional memory controller enhanced with the following features:
a. One or more registers that enable the controller to address specific locations in either integrated, main-memory-resident or I/O-resident buffers and that can be incremented or decremented as data is added to, or removed from, those buffers.
b. Additional registers that can be used to store temporarily certain buffer addresses.
c. A register containing status bits some of which can be hard wired while others can be set and reset by the memory controller itself or by any central processor.
d. Augmented control and sequencing logic that implement either directly, or in cooperation with software programs executable by any central processor, procedures for storing to and copying from the aforementioned buffers addresses of memory blocks that have been, are about to be, or potentially may be modified, with or without also storing the corresponding data in an associated data buffer.

2. The apparatus of claim 1, having some or all of the following registers:
a. An address register, used for accessing a dedicated or main-memory-resident data buffer, in which the most-significant bits are either settable or hard-wired and the least-significant bits are implemented in a counter that can be cleared and either incremented or decremented or both and that resets to zero when incremented past its maximum count.
b. A second address register, used for accessing a second dedicated or main-memory-resident data buffer in which the most-significant bits are also either settable or hard-wired and the least-significant bits are implemented in a counter that can be cleared and either incremented or decremented or both and that resets to zero when incremented past its maximum count.
c. An address register, used for accessing a dedicated or main-memory-resident address buffer, in which the most-significant bits are either settable or hard-wired and the least-significant bits are implemented using the most significant bits of the same counter as one of the address-buffer address registers.
d. A second address register, used for accessing a second dedicated or main-memory-resident address buffer, in which the most-significant bits are either settable or hard-wired and the least-significant bits are implemented using the most significant bits of the same counter as the other address-buffer address register.
e. A third address register, used for accessing the same address buffer as the first address-buffer address register, sharing the most-significant bits with the first address-buffer address register and in which the least-significant bits are implemented in a separate counter that can be cleared and incremented.
f. A register that can be loaded from the first of the previously described counters.
g. A second register that can be loaded from the first of the previously described counters.
h. A settable or hardwired register defining the number of buffer entries that determine when the buffer is nearing capacity.
i. An interface to a bit-map memory, that may or may not be integrated into the memory controller itself, with one bit corresponding to each physical data block in main memory, the interface including the ability to address any individual location in the bit-map memory and the ability to cycle through all of its addresses in sequence.
j. A second interface to a second bit-map memory, that may or may not be integrated into the memory controller itself, with one bit corresponding to each physical data block in main memory, the interface including the ability to address any individual location in the bit-map memory and the ability to cycle through all of its addresses in sequence.
k. Logic that enables the two aforementioned bit-map memories to be accessed as a single memory having two bits corresponding to every physical block in main memory.
l. Logic that enables the controller to generate processor-visible interrupts whenever certain status bits are set or reset.

3. The apparatus of claim 1 with the status register containing all, or any subset of, the following status bits, some of which may be hardwired and all of which, if not hardwired, are settable and resettable by any system processor:
a. A status bit that, when set indicates that the system is implementing local checkpointing;
b. A status bit that, when set, indicates that the system is implementing remote checkpointing;
c. A status bit that, when set, indicates that the system is serving as a backup computer for some other computer;
d. A status bit that, when set, indicates that the system is in fault mode and causes the memory controller to respond to all I/O read attempts by supplying data consisting of all zeros and to respond to all I/O write attempts in the normal way, but without storing any data to main memory;
e. A status bit, also resettable by the memory controller, that, when set, indicates that the system is in checkpoint mode;
f. A status bit, also settable and resettable by the memory controller, that, when set, indicates that the data associated with a given checkpoint has all been copied to its backup location.
g. A status bit, also resettable by the memory controller, that, when set, indicates that the system is in rollback mode;
h. A status bit, also settable and resettable by the memory controller, that indicates which address/data buffer pair is currently being used to store new data blocks or which bit-map is currently associated with new data modifications;
i. A status bit, also settable and resettable by the controller, to indicate that a buffer is reaching capacity;
j. A status bit indicating which of its memory banks is serving as a shadow memory when system-level checkpointing features are enabled or when it is serving as a backup for a remote primary computer.
k. A status bit that defines whether the action that precipitates the capture of an address and, if appropriate, its associated data is a write to main memory or, alternatively, any access that may result in a subsequent write to main memory as indicated by the cache-coherency protocol being implemented by the memory controller.
l. A status bit that can be set prior to certain copying operations to enable bus snooping.
m. Three status bits that determine which of the following checkpoint methodologies is being implemented:
i. Copies of all captured addresses are stored to a FIFO buffer.
ii. Copies of both captured addresses and the associated data are stored in FIFO buffers.
iii. Copies of both captured addresses and the associated data are routed to an I/O connection.
iv. Copies of both captured addresses and the associated data are stored in one of two FIFO buffers depending on the state of a status bit.
v. A bit is set in a bit-map memory corresponding to captured address and the data is stored to a data buffer.
vi. A bit is set in one of two bit-map memories, depending on the state of a status bit.
vii. The state of each main-memory block is maintained in a bit-map memory having two bits corresponding to each data block in main memory.
viii. The captured addresses and associated pre-modified data are stored to LIFO buffers.

4. The apparatus of claim 1, with control and sequencing logic supporting any or all of the following actions:
a. Capture all write addresses.
b. Capture the addresses of all main-memory blocks that are determined through the cache-coherency protocol to be subject to subsequent modification.
c. Store all captured-addresses to a FIFO address buffer.
d. Read the addresses from the address buffer in FIFO order and move a copy of the contents of the associated location in main memory to a corresponding location in a local shadow memory.
e. Copy both the addresses from the FIFO buffer and the data corresponding to those address from the computer's main memory to a remotely located shadow memory to an I/O connection designated for that purpose.
f. Support standard flow-control procedures enabling the backup remote computer to halt further data transfers until it has space in its input buffer for that data.
g. Send certain change-of-status information to a designated I/O connection.
h. Copy data with bus snooping either enabled or disabled.

5. The apparatus of claim 1, with control and sequencing logic supporting any or all of the following actions:
a. Transfer to a designated I/O connection, using any standard transfer protocol, simultaneously with each write to main memory, both the block being written and its associated address.
b. Relay certain change-of-status information to the designated I/O connection.
c. Delay main-memory accesses if necessary until receipt of both the data and address associated with any previous memory write and transferred to an I/O connection have been acknowledged.

6. The apparatus of claim 1, with control and sequencing logic supporting any or all of the following actions:
a. Maintain two pairs of FIFO address and data buffers and their associated address registers.
b. Store new captured data-block addresses along with a copy of the associated data to either of the two FIFO buffer pairs, as determined by the relevant status bit, and, concurrently, move data from the other data buffer to those locations in a local shadow memory defined by the corresponding addresses in the other address buffer.
c. Store new captured data-block addresses along with a copy of the associated data to either of the two FIFO buffer pairs, as determined by the relevant status bit, and, concurrently, to transfer, from the other pair, the addresses and the data blocks associated with those addresses, to a designated I/O connection and also to send certain change-of-status information to the I/O connection.
d. Transfer addresses and data blocks from the same buffer into which new addresses and data are being written once the other buffer pair has been emptied.
e. Delay subsequent memory accesses until both the data and the address associated with any previous memory write have been stored in their respective buffers.
f. Toggle the status bit identifying which of the two buffer pairs is being used to store new captured data when in checkpoint mode and when the transfer of all data from the alternate pair has been completed.
g. Transfer to an end-count register the contents of either of its buffer counters on certain change-of-status events.
h. Treat the two address buffers as a single circular buffer and the two data buffers as a second single circular buffer.

7. The apparatus of claim 6 further enhanced with either an integrated internal bit-map memory or the interface to an external bit-map memory, such memory containing one bit for every physical block in the main memory and having enhanced control, with control and sequencing logic supporting any or all of the following actions:
a. Set the corresponding bit in the bit-map memory whenever the address of a data block that has been, or potentially will be, modified is captured.
b. Store newly captured addresses and the associated data blocks to either of the two FIFO buffer pairs, as determined by the relevant status bit, and, concurrently, to transfer, in LIFO order, the data blocks from the other pair to the locations in a local shadow memory defined by their associated addresses in the address-buffer.
c. Store newly captured addresses and data blocks to either of the two FIFO buffer pairs, as determined by the relevant status bit, and, concurrently, to transfer, from the other pair, in LIFO order, the addresses and the data blocks associated with those addresses, to a designated I/O connection and to send certain change-of-status information to the I/O connection.
d. Reset the corresponding bit in the bit-map memory on each transfer to a local shadow memory or to an I/O connection from the data buffer not currently being used to capture new data if the corresponding bit in the bit-map memory is set and abort the transfer if it is not set.
e. Transfer, in FIFO order, from the buffer pair currently storing new write addresses and data to an I/O connection, without setting any bits in the bit-map memory, once all addresses and data from the alternate buffer pair have already been transferred.
f. Treat the two address buffers as a single circular buffer and the two data buffers as a second single circular buffer.
g. Copy data with bus snooping either enabled or disabled.

8. The apparatus of claim 6 configured to operate in a backup computer with one of its associated buffer pairs loaded through a designated I/O connection using standard DMA procedures while the other is used to transfer previously loaded data to the appropriate locations in its shadow memory, the modifications needed to support this mode of operation including the ability for its end-count register to be loaded by a system processor.

9. The apparatus of claim 6 further enhanced so as to support simultaneously those operations needed to collect and transfer checkpoint data to a remote computer and to maintain a shadow memory for a, possibly different, remote computer.

10. The apparatus of claim 1 with control and sequencing logic that enables it to maintain two integrated or externally accessible bit-map memories, each having a one-bit entry for every block in main memory and to support any or all of the following operations:
a. Set a bit in one of the bit-map memories, the “modified-map”, whenever the corresponding main-memory block is about to be modified and reset a bit in the second bit-map memory, the “copy-map”, whenever the corresponding main-memory block is either moved to a corresponding location in a local shadow memory or, along with its address, to a designated I/O connection.
b. Check the corresponding bit in the copy-map prior to a write to any main memory block and 1) if the bit is set, defer the write until the pre-modified block can be copied to its backup location and the bit reset; 2) set the corresponding bit in the modified-map.
c. Sequence through the entire copy-map and 1) copy all main-memory blocks, and, if checkpointing to a remote location, the associated addresses, corresponding to the copy-map bits that are set, to their backup locations; 2) reset the corresponding copy-map bit; 3) set the checkpoint-copy-complete bit and toggle the modified-map-pointer status bit when all bits in the copy-map memory have been reset.
d. Do all of the above when the operation causing the modified-map bit to be set and causing further such operations to be deferred when the copy-bit is set, is any operation, as determined by the cache-coherency protocol being implemented by the controller, that potentially modifies the corresponding main-memory block and effecting the copying operation with bus snooping enabled.

11. The apparatus of claim 1 with control and sequencing logic capable of maintaining an integrated or externally accessible block-state memory having one two-bit entry for every physical block in main memory and supporting any or all of the following operations:
a. On each write to a main-memory block:
i. If the current state in the block-state memory corresponding to the address of the block being written is 00, change the state to 11 and direct the write to the main-memory address obtained by complementing the most significant bit of the write address;
ii. If the current state is 01, set the state to 10 and direct the write to the addressed main-memory block;
iii. If the current state is 10, leave it unaltered and direct the write to the addressed main-memory block;
iv. If the current state is 11, leave it unaltered and direct the write to the main-memory address obtained by complementing the most significant bit of the write address.
b. When in checkpoint mode, set the most significant bit of each entry in the block-state memory to 0 and reset the checkpoint-mode status bit;
c. When in rollback mode, set the most-significant bit of all entries in the block-state memory to 0; set the least-significant bit of every entry in the block-state memory to the exclusive-or of the two bits of its current state, and reset the rollback bit.

12. The apparatus of claim 1 with control and sequencing logic capable of maintaining a pair of LIFO address and data buffers for storing the address of each data block being written to along with a copy of the data that was stored at that location prior to its being modified and implementing any or all of the following capabilities:
a. Delay any attempt to write to a main-memory block until it has stored the block address in the LIFO address buffer at the location indicated by the address-buffer register, copied the current contents of data block a to the corresponding location in the LIFO data buffer and incremented the buffer-address-register counter.
b. Delay any further operation that may potentially result in the modification of a memory block, as determined by the cache coherency protocol being implemented by the memory controller, until it has stored the block address in the LIFO address buffer at the location indicated by the address-buffer register, copied the current contents of data block a to the corresponding location in the LIFO data buffer and incremented the buffer-address-register counter.
c. Set the checkpoint-mode status bit and reset the buffer-address-register counter when it receives a command to enter checkpoint-mode, then reset the checkpoint-mode status bit.
d. Set the rollback-mode status bit when it receives an enter-rollback mode command, decrement the current buffer address, move the contents of the LIFO data buffer entry back to the main-memory location indicated by the corresponding entry in the LIFO address buffer and continue this operation until the buffer address counter is decremented past 0.

13. The apparatus of claim 1, with control and sequencing logic that enables it to implement all of the functionality described in the previous claims with the specific functionality to be implemented in any given application determined by the status register bits described in claim 4(n).

14. Apparatus in an I/O device that supports any standard I/O protocol consisting either of an I/O processor program or control and sequencing logic implementing the transfer of both the data received through an I/O connection and the addresses associated with that data, as well as any change-of-status information, to a similar I/O device in a remote computer.

15. The apparatus of claim 14 with either a software program or control and sequencing logic that, when it is used in a backup computer, implements the transfer, employing standard direct-memory access (DMA) procedures, of received data blocks to their designated locations in the backup computer's shadow memory, following receipt of certain change-of-status information.

16. The apparatus of claim 14 with the ability to generate a central processor interrupt when its buffers are nearing capacity and upon certain change-of-status events.

17. The apparatus of claim 14 implementing two independent pairs of address and data buffers and having control and sequencing logic that enables it to load addresses and data received through its local I/O connection into either one of the buffer pairs while it relays the previously loaded contents of the other buffer pair to its companion I/O device in the backup computer, or else implementing a pair of unified, circular buffers in which checkpoint boundaries are maintained so that post-status-change addresses and data being loaded into the unified buffer are kept distinct from pre-status-change addresses and data being relayed to the companion I/O device.

18. The apparatus of claim 17 in which, when operating in the backup computer, has control and sequencing logic that enables it to DMA the post-status-change data blocks to the main-memory locations defined by their associated addresses while buffering pre-status-change addresses and data received from its companion I/O device in the primary computer.

19. The procedure by which a suitably enhanced memory controller is used to implement, either autonomously or with software support, any or all of the following checkpointing strategies:
a. Post-image checkpointing using a main-memory resident address buffer.
b. Post-image checkpointing using main-memory resident address and data buffers.
c. Post-image checkpointing using I/O resident address and data buffers.
d. Post-image checkpointing using two main-memory resident address buffers and two main-memory resident data buffers.
e. Post-image checkpointing using a bit-map memory.
f. Post-image checkpointing using two bit-map memories.
g. Post-image checkpointing using a block-state memory.
h. Pre-image checkpointing using main-memory resident address and data buffers.

20. The procedure of claim 19 in which the data to be checkpointed consists of either of the following:
a. All main-memory blocks that have been modified since the last checkpoint.
b. All main-memory blocks that have either been modified since the last checkpoint or may subsequently be modified, as determined by the operative cache-coherency protocol.

21. The procedure of claim 19 involving, either autonomously or with software support, the following operations:
a. Capture the addresses of all main-memory blocks that are to be checkpointed and store them in a buffer.
b. Monitor the number of captured addresses and declare a checkpoint when the buffer nears capacity.
c. Following the declaration each checkpoint, access the buffered addresses in FIFO order and effect the transfer of a copy of the corresponding data blocks to the appropriate locations in a local or remote shadow memory, delaying further memory modifications until the copying has been completed.

22. The procedure of claim 19 involving, either autonomously or with software support, the following operations:
a. Capture the addresses of all main-memory blocks that are to be checkpointed and store them, along with a copy of the modified data, in one of two pairs of buffers, one buffer in each pair used for the addresses and the second for the data.
b. Monitor the number of captured addresses and declare a checkpoint when the buffers being stored to near capacity.
c. Concurrently with the above operations, access, in FIFO order, the addresses in the buffer not currently being loaded and effect the transfer of the corresponding data blocks from the data buffer to the appropriate locations in a local or remote shadow memory, continuing this operation until the buffers are empty.
d. When the buffers being unloaded are empty, record that the local shadow memory has been updated to the state that existed at the last checkpoint or, if checkpointing to a remote location, inform the backup computer that all the data associated with a given checkpoint has been transferred to it
e. If the data is being copied to a remote location, continue copying addresses and data from the buffer pair currently being loaded unless the buffers are empty.
f. When a checkpoint is declared, reverse the roles of the two buffer pairs as soon as the buffer that was not being loaded has been emptied

23. The procedure of claim 22 in which the two address buffers are implemented as a single circular buffer with snapshots taken of the buffer addresses each time a checkpoint is declared and used to distinguish between the buffer being loaded and that being unloaded and in which the two data buffers are similarly implemented.

24. The procedure of claim 22 in which a bit-map memory is used to obviate the need to copy any given physical memory block more than one to effect a checkpoint.

25. The procedure of claim 19 in which the apparatus of claim 10 is used to maintain two bit-maps, each containing one bit corresponding to each physical block in main memory and to implement, either autonomously or with software support, the transfer of the data blocks associated with bits set in the bit-map representing data blocks that were modified prior to the last checkpoint to their backup locations concurrently with normal computer operations.

26. The procedure of claim 19 in which the two-bit state memory is maintained, using the apparatus of claim 11, by setting the most significant of the two bits to “0” at the instantiation of each checkpoint and by setting the least significant bit to the exclusive-or of the two state bits whenever a rollback is necessitated and then again setting the most significant bit to “0”.
